(19) United States
(12) Patent Application Publication
(10) Pub. No.: US 2017/0331165 A1
(43) Pub. Date: Nov. 16, 2017

(54) BATTERY SYSTEM

(71) Applicant: Obrist Technologies GmbH, Lustenau (AT)

(72) Inventors: Frank Obrist, Bregenz (AT); Martin Graz, Lustenau (AT); Joachim Georg Roth, Dornbirn (AT)

(21) Appl. No.: 15/514,507

(22) PCT Filed: Sep. 22, 2015
(86) PCT No.: PCT/EP2015/071632

§ 371 Date: Jul. 24, 2017

(30) Foreign Application Priority Data
Sep. 26, 2014 (DE) 102014114020.6

(51) Int. Cl. H01M 10/6557; H01M 10/625; H01M 10/42; H01M 10/613; H01M 2/10; H01M 10/643; H01M 2/20; H01M 10/0525

(52) U.S. Cl. CPC H01M 10/6557; H01M 2/206; H01M 10/625; H01M 10/425; H01M 10/0525; H01M 10/613; H01M 2/1077; H01M 10/643; H01M 2010/4271; H01M 2220/20

(57) ABSTRACT

The invention relates to a battery system, in particular for a hybrid drive, having a housing which has a fluid connector segment, an energy store segment and an electrics/electronics segment, wherein the energy store segment has at least two cooling elements, through which a flow can pass, and at least one cell block, which are formed in each case from a plurality of battery cells that are connected electrically and mechanically by way of contact plates, and wherein the cell block is arranged between two cooling elements. The invention is characterised in that the energy store segment is arranged between the fluid connector segment and the electrics/electronics segment and has a cuboidal volume which corresponds to at least 0.5 times the total internal volume of the housing.

The invention relates to a battery system, in particular for a hybrid drive, according to the preamble of claim 1, and to a vehicle comprising a battery system of this type. A battery system of this type is known for example from EP 2 744 034 A, which can be traced back to the applicant.

In the known battery system, cell blocks are arranged in a housing and are separated from one another by cooling elements. Fluid connectors are provided on the end side of the cell blocks, wherein the wiring of the individual cell blocks to one another is arranged between the fluid connectors. In this respect, the housing can be divided into a plurality of segments, wherein a distinction is made between an energy store segment, an electrics/electronics segment and at least one fluid connector segment.

Specifically, in the battery system according to EP 2 744 034 A1, two fluid connector segments are provided, between which the electrics/electronics segment extends. The fluid connector segments and the electrics/electronics segment are arranged on the same end side of the energy store segment. Connector lines for merging a plurality of fluid channels are provided in the fluid connector segments and take up a relatively large amount of installation space, which has proven to be disadvantageous in respect of the external dimensions of the known battery system. In addition, the spatial vicinity of the electrics/electronics segment and fluid connector segment has proven to be precarious.

In this respect, one object of the present invention is to further develop a battery system of the type mentioned in the introduction, in such a way that it has a compact overall size and increased operational safety. A further object of the invention is to specify a vehicle comprising such a battery system.

This object is achieved in accordance with the invention by the subject matter of claim 1.

Therefore, what is proposed is a battery system, in particular for a hybrid drive, having a housing which has a fluid connector segment, an energy store segment, and an electrics/electronics segment. The energy store segment has at least two cooling elements through which a flow can pass, and at least one cell block. The cell block is formed from a plurality of battery cells that are connected electrically by way of contact plates. Here, the cell block is arranged between the two cooling elements. In accordance with the invention, the energy store segment is arranged between the fluid connector segment and the electrics/electronics segment.

With the embodiment according to the invention of the battery system, on the one hand an increased operational safety is achieved, since the fluid connector segment and the electrics/electronics segment are separated from one another by the energy store segment. In particular, the fluid connector segment can be arranged on an end side and the electrics/electronics segment can be arranged on an opposite end side of the housing, such that a physical separation is provided, which reduces the risk of a short circuit leading to a thermal event.

In addition, it is provided in the case of the invention that the energy store segment has a cuboidal volume which corresponds at least to 0.5 times the total internal volume of the housing. A particularly high packing density is thus provided, which results in the fact that the outer dimensions of the battery system, in particular of the housing, are reduced compared to the previously known battery. This opens up further possibilities for integration of the battery system in a hybrid drive, wherein at the same time a high storage capacity is provided. With use of the battery system in a vehicle, the operating distance of the vehicle can thus be increased in spite of compact dimensions of the battery system.

In a particularly preferred embodiment of the invention it is provided that the energy store segment has at least three cooling elements through which a flow can pass and at least two cell blocks arranged one above the other, wherein each cell block is arranged between two cooling elements.

In order to further increase the storage density with small outer dimensions or in order to further reduce the outer dimensions whilst maintaining the same storage density, it is provided in particularly preferred variants of the invention that the cuboidal volume corresponds at least to 0.55 times, in particular at least 0.6 times, in particular at least 0.62 times, in particular at least 0.65 times the total internal volume of the housing. In this regard, it should be noted that the cuboidal volume is determined by measurements of the edge lengths of the individual segments.

The battery cells of the battery system can be formed in particular by round cells, in particular of the 18650 type. Round cells of this type are available in high quantities and at low cost, and therefore the battery system can be economically produced.

With regard to compact outer dimensions of the battery system, it is preferred if the housing has a total height of at most 200 mm, in particular at most 190 mm, in particular at most 180 mm, in particular at most 170 mm, in particular at most 160 mm.

In preferred variants of the invention, all detachable electrical connectors and/or all detachable fluid connectors are arranged outside the housing. This further benefits the operational safety of the battery system, since a leak at the detachable fluid connectors does not lead to an accumulation of fluid within the housing. Rather, an advantageous separation from component parts which carry electrical current is produced.

An electronic circuit board for a battery monitoring system can be arranged laterally along the cell block and is associated with the energy store segment. The electronic circuit board can be used to monitor the voltage and/or temperature of the individual battery cells and is advantageously formed and coupled to the cell block in such a way that the cuboidal volume of the energy store segment at most changes slightly, and preferably remains unchanged, as a result of the installation of the electronic circuit board in the battery system.

Within the scope of a coordinated aspect, the invention additionally relates to a vehicle, in particular hybrid vehicle, having a battery system as described above. Due to the small outer dimensions of the battery system alongside high storage density, the battery system can be integrated easily and in a space-saving manner into a vehicle.

The present invention will be explained in greater detail on the basis of an exemplary embodiment with reference to the accompanying, schematic drawings, in which

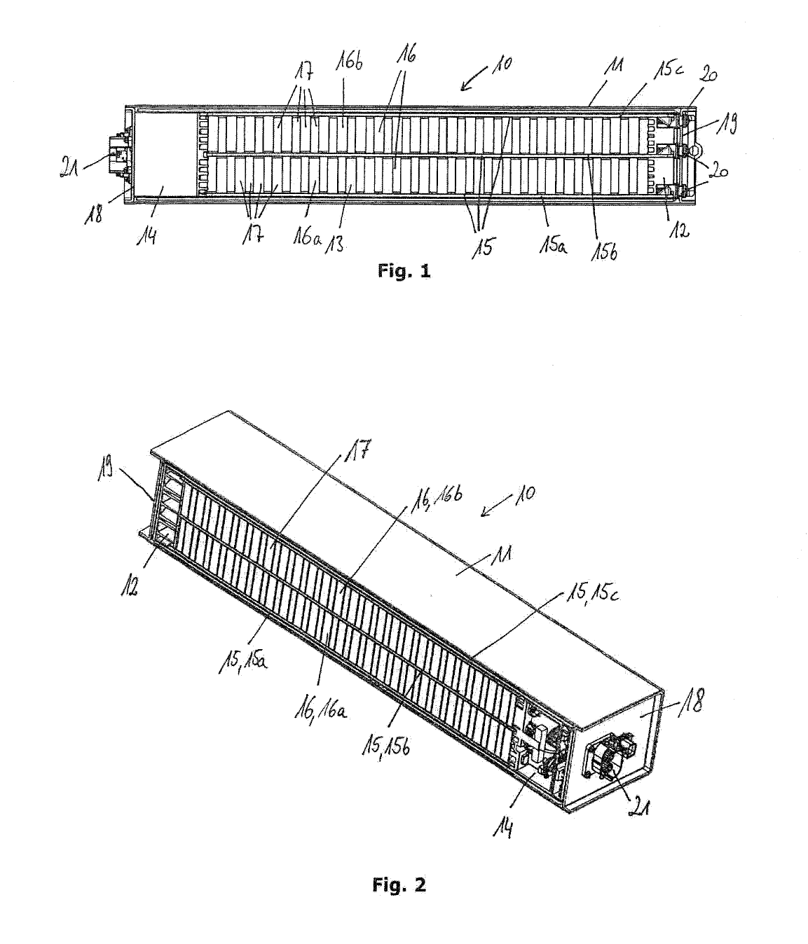

FIG. 1 shows a longitudinal sectional view through a housing of a battery system according to the invention; and

FIG. 2 shows a perspective view of the longitudinal section through the housing 1.

The battery system has a housing 11, which can be divided into a fluid connector segment 12, an energy store segment 13, and an electrics/electronics segment 14. This functional division is thus structural insofar as the energy store segment 13 substantially encloses a cuboidal volume in which there are arranged at least two cell blocks 16 arranged one above the other, each cell block being arranged between two cooling elements 15 through which a flow can pass.

The energy store segment 13 is defined by the outer edges of a cuboid, which has at least one lower cooling element 15a, a lower cell block 16a, a middle cooling element 15b, an upper cell block 16b, and an upper cooling element 15c. The cell blocks 16 are each formed from a plurality of battery cells 17, which are electrically and mechanically connected to one another by way of contact plates. On the whole, the height of the cuboidal volume is thus calculated from the layered structure of cooling elements 15 and cell blocks 16, wherein the cell blocks 16 have a height which corresponds to the height of the battery cells 17 plus twice the thickness of a contact plate.

A cuboidal volume for the energy store segment which corresponds at least to 0.5 times the total internal volume is preferably created. Here, it is provided in particular that the housing has a cuboidal internal volume. In specific embodiments, the cuboidal volume can also correspond at least to 0.55 times, in particular at least 0.6 times, preferably at least 0.62 times, particularly advantageously at least 0.65 times the total internal volume of the housing 11.

In a specific design, the internal volume of the housing 11 is approximately 54 l, wherein the cuboidal volume of the cell block 16 is approximately 36 l.

The battery cells are formed by round cells. The round cells by way of example can each have a cross-sectional diameter of 18 mm and a height of 65 mm. The round cells are preferably lithium-ion cells of the 18650 type. Here, it can be provided that the battery cells 17 are arranged in rows, wherein a plurality of rows of battery cells 17 arranged adjacently are combined to give a cell block 16. Here, the adjacent rows can be arranged offset in relation to one another, in particular by in each case approximately half the cell diameter, such that a particularly high packing density within the cell blocks 16 is achieved. This has a positive effect on the overall dimensions of the battery system. In other words, an increased energy storage density can be achieved with unmodified size of the housing 11.

In the exemplary embodiment of the battery system 10 illustrated in the drawings, a total of 768 battery cells 17 are provided per cell block 16. In spite of the high number of battery cells 17, the housing 11 preferably has an overall height which is between 160 mm and 180 mm, in particular approximately 170 mm.

The cooling elements 15 can be formed as cooling bags or cooling pockets, which have flexible outer walls. The cooling elements 15 in any case can be passed through by a flow of coolant, for which purpose the cooling elements 15 each comprise fluid connectors 20. The fluid connectors 20 are arranged on a connector end of the corresponding cooling element 15 and extend from the energy store segment 13 into a fluid connector segment 12. The fluid connector segment 12 is delimited by a rear end wall 19 of the housing 11. The fluid connectors 20, which are connected to the cooling elements 15 integrally, i.e. not detachably, extend through the rear end wall 19 and are secured and sealed in the rear end wall 19.

The electrics/electronics segment 14 is arranged on the side of the energy store segment 13 opposite the fluid connector segment 12. The electrics/electronics segment 14 contains all electrical wiring and electronic components which are necessary in order to connect the cell blocks 16 to an electrical connector 21 on a front end wall 18 of the housing 11. The electrical connector 21 can comprise both a power connector and a signal and/or data connector.

The electrical connector 21 is arranged on an outer side of the front end wall 18 and is secured to the front end wall 18 and is sealed with respect thereto. The electrical connector 21 and the fluid connectors 20 provide plug connections in order to integrate the battery system in a hybrid drive. Here, it is preferably provided in the exemplary embodiment illustrated in the drawings that all detachable electrical connectors 21 and all detachable fluid connectors 20 are arranged outside the housing 11. This increases the operational safety of the battery system 10. However, with regard to a further increase of the packing density, it is also conceivable that either the fluid connectors 20 or the electrical connector 21 are/is arranged outside the housing.

For the sake of completeness, it should be mentioned here that the energy store segment 13 can additionally comprise one or more electronic circuit boards, which are mechanically and electrically connected directly to the cell blocks 16 in order to provide a battery monitoring. The electronic circuit board fundamentally enables a tapping of the voltages over individual rows of individual battery cells 17. At the same time, the electronic circuit board can be used to measure the temperature of the individual cell blocks 16. It is fundamentally provided that the electronic circuit board is arranged flush on a side face along the cell block 16, in such a way that the electronic circuit board is fully arranged the cuboidal volume of the energy store segment. Electronic circuit boards of this type, preferably a single one of which is arranged on each cell block 16, are not added to the electrics/electronics segment 14 in order to calculate the cuboidal volume, but instead are added to the energy store segment 13, wherein the electronic circuit board is preferably integrated in a closely-fitting and flush manner between the contact plates of the cell blocks 16, in such a way that it has hardly any influence on the calculation of the cuboidal volume.

### REFERENCE LIST

10 battery system
11 housing
12 fluid connector segment
13 energy store segment
14 electrics/electronics segment
15 cooling element
15a lower cooling element
15b middle cooling element
15c upper cooling element
16 cell block
16a lower cell block
16b upper cell block
17 battery cell
18 front end wall
19 rear end wall
20 fluid connector
21 electrical connector

1. A battery system, in particular for a hybrid drive, having a housing which has a fluid connector segment, an energy store segment and an electrics/electronics segment, wherein the energy store segment has at least two cooling elements, through which a flow can pass, and at least one cell block, which is formed from a plurality of battery cells that are connected electrically and mechanically by way of contact plates, and wherein the cell block is arranged between two cooling elements,
characterized in that
the energy store segment is arranged between the fluid connector segment and the electrics/electronics segment and has a cuboidal volume which corresponds to at least 0.5 times the total internal volume of the housing,
wherein the battery cells are formed by round cells, in particular of the 18650 type, and the housing has a total height of at most 200 mm, in particular at most 190 mm, in particular at most 180 mm, in particular at most 170 mm, in particular at most 160 mm.

2. The battery system according to claim 1,
characterized in that
the cuboidal volume corresponds at least to 0.55 times, in particular at least 0.6 times, in particular at least 0.62 times, in particular at least 0.65 times the total internal this a if a the a volume of the housing.

3. The battery system according to claim 1,
characterized in that,
all detachable electrical connectors and/or all detachable fluid connectors are arranged outside the housing.

4. (canceled)

5. (canceled)

6. The battery system according to claim 1,
characterized in that
an electronic circuit board for a battery monitoring system is arranged laterally along the cell block and is associated with the energy store segment.

7. A vehicle, in particular hybrid vehicle, having a battery system according to claim 1.
